(19) United States
(12) Patent Application Publication
(10) Pub. No.: US 2012/0127064 A1
(43) Pub. Date: May 24, 2012

(54) ORGANIC ELECTROLUMINESCENT DISPLAY APPARATUS

(75) Inventors: Fujio Kawano, Kawasaki-shi (JP); Tatsuhito Goden, Chiba-shi (JP); Noriyuki Shikina, Ichihara-shi (JP); Kiyofumi Sakaguchi, Mobara-shi (JP); Takanori Yamashita, Chiba-shi (JP); Kouji Ikeda, Chiba-shi (JP)

(73) Assignee: CANON KABUSHIKI KAISHA, Tokyo (JP)

(21) Appl. No.: 13/286,406

(22) Filed: Nov. 1, 2011

(30) Foreign Application Priority Data
Nov. 18, 2010 (JP) 2010-257541

(51) Int. Cl. G09G 3/30

(52) U.S. Cl. 345/76

(57) ABSTRACT

Provided is a display apparatus that can select either an “outdoor visibility mode” or a “wide viewing angle mode” or either a “power saving mode” or a “wide viewing angle mode” depending on a user scene; that can also select intermediate states between the two modes; and provide high displayed image quality. An organic electroluminescent display apparatus of the present invention includes a plurality of pixels, an organic electroluminescent element, a data line driver, a pixel circuit, and a gate line driver, in which each pixel includes two organic electroluminescent elements that emit light of the same color, an element with high light-collecting property is disposed over a light emission side of only one of the two organic electroluminescent elements, and units that make a difference in lighting times or drive currents between the two organic electroluminescent elements are included.

### BACKGROUND OF THE INVENTION

1. Field of the Invention

The present invention relates to a display apparatus using an organic EL (Electroluminescent) element, and particularly, to an active matrix organic EL display apparatus that can improve efficiency of utilization of light from the front side of an organic EL element.

2. Description of the Related Art

In an organic EL element, since light is emitted at various angles from an emission layer, a large amount of light components are totally reflected at the boundary between a protective layer and an external space, and some of the totally reflected light components are confined inside the element. Therefore, there is a problem that the light extraction efficiency is reduced. To solve the problem, a microlens array made of resin is arranged over a silicon oxynitride (SiNxOy) film that seals the organic EL element in Japanese Patent Application Laid-Open No. 2004-039500.

In a configuration in which the microlens array is arranged over the organic EL element as in Japanese Patent Application Laid-Open No. 2004-039500, a light-collecting effect can be expected in addition to an effect of extracting light components that would otherwise be totally reflected without a microlens array. The effects can improve the front luminance (light extraction efficiency in a front direction, i.e. a normal direction of the substrate) of a display apparatus using the organic EL element. However, the luminance in an oblique direction of the display apparatus is reduced, and it is difficult to use the configuration when wide viewing angle characteristics are needed.

In a configuration in which an interference effect is imparted to the organic EL element, the luminance is high in a direction (optical path length) in which a constructive interference effect is effective. However, the luminance is low in a direction in which the constructive interference effect is weak, and therefore it is also difficult to use the configuration when wide viewing angle characteristics are needed.

### SUMMARY OF THE INVENTION

An object of the present invention is to provide an organic EL display apparatus with high display image quality that allows selecting either an “outdoor visibility mode” or a “wide viewing angle mode” and either a “power saving mode” or a “wide viewing angle mode” depending on a user scene and that also allows selecting intermediate states between the two modes.

To solve the problems, the present invention provides an organic EL display apparatus including: a plurality of pixels arranged in a matrix; an organic EL element arranged on each of the pixels; a data line driver that supplies a data signal according to image data to each of the pixels; a pixel circuit that is arranged on each of the pixels and includes a plurality of transistors, the pixel circuit supplying a drive current according to the data signal to the organic EL element to light the organic EL element; and a gate line driver that drives the transistors, wherein each of the pixels includes two organic EL elements that emit light of a same color, an element with high light-collecting property is disposed over a light emission side of only one of the two organic EL elements, and the apparatus further including units that make a difference in lighting times or drive currents between the two organic EL elements.

According to the present invention, it is possible to make a difference in lighting times or drive currents between an “area with high light-collecting element” and an “area without high light-collecting element” within one pixel from common image data. As a result, either an “outdoor visibility mode” or a “wide viewing angle mode” and either a “power saving mode” or a “wide viewing angle mode” can be selected according to the user scene, and intermediate states between the two modes can also be selected. An organic EL display apparatus with high display image quality can be realized.

Further features of the present invention will become apparent from the following description of exemplary embodiments with reference to the attached drawings.

### BRIEF DESCRIPTION OF THE DRAWINGS

FIGS. 1A, 1B, and 1C are schematic diagrams illustrating an organic EL panel, a pixel configuration, and a pixel arrangement according to the present invention.

FIG. 2 illustrates relative luminance to viewing angle characteristics of sub-pixels including organic EL elements according to the present invention.

FIG. 3 is an operation timing chart of modes of the organic EL panel according to the present invention.

FIG. 4 illustrates relative luminance to viewing angle characteristics of the modes of the organic EL panel according to the present invention.

FIG. 5 illustrates relative power characteristics of the modes of the organic EL panel according to the present invention.

FIG. 6 illustrates relative drive current characteristics of the modes of the organic EL panel according to the present invention.

FIGS. 7A, 7B, and 7C are schematic diagrams of an organic EL panel, a pixel configuration, and a pixel arrangement of Example 1.

FIG. 8 illustrates a pixel circuit of Example 1.

FIG. 9 is an operation timing chart of the organic EL panel of Example 1.

FIG. 10 is a schematic diagram of the organic EL panel of Example 2.

FIG. 11 illustrates the pixel circuit of Example 2.

FIG. 12 illustrates an example of a unit that generates two data signals from one image data.

FIGS. 13A and 13B are operation timing charts of the organic EL panel of Example 2.

FIG. 14 illustrates the pixel circuit of Example 3.

FIGS. 15A and 15B are operation timing charts of the organic EL panel of Example 3.

### DESCRIPTION OF THE EMBODIMENTS

Preferred embodiments of the present invention will now be described in detail in accordance with the accompanying drawings.

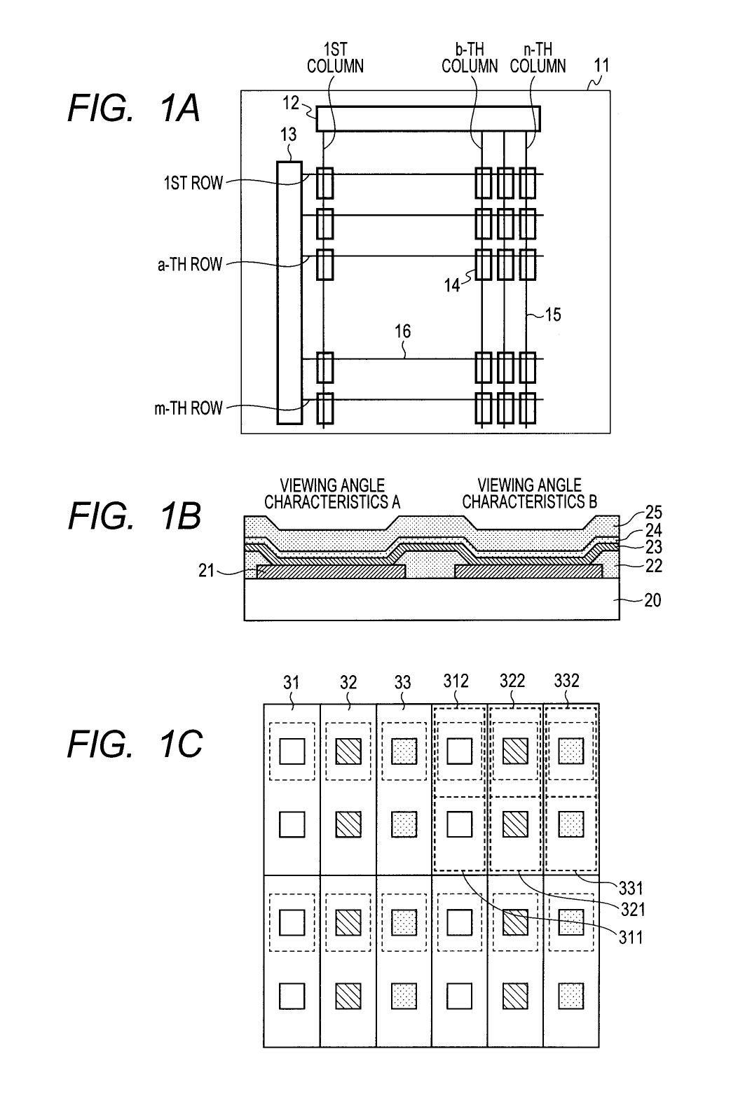

FIG. 1A is a schematic diagram of an organic EL panel 11 including a plurality of pixels (pixels of m rows and n columns) arranged in a matrix and including an organic EL element arranged on each of the pixels. The organic EL panel 11 is an example of the organic EL panel according to the present invention. The organic EL panel 11 includes a data line drive circuit 12 that applies a data signal to a data line 15 and a gate line drive circuit 13 that drives a gate line 16. The organic EL panel 11 further includes a pixel circuit 14 that is arranged on each pixel and that includes a plurality of transistors. The pixel circuit 14 supplies a drive current according to the data signal to the organic EL element to light the organic EL element. The pixels of m rows and n columns are arranged at intersections of the data lines and the gate lines, and the display is based on data signals corresponding to the pixels.

The data line drive circuit 12 is a data line driver that supplies data signals according to image data to the pixels and is a circuit that receives image data from the outside to control the amount of current for driving the organic EL element according to the image data. The gate line drive circuit 13 is a gate line driver that drives each transistor included in the pixel circuit 14 (drives the gate line 16 connected to the gate terminal of each transistor) and generates a pulse signal during a writing operation of a target row. In general, the writing operation is sequentially performed from the first row. Therefore, a shift register or other logic circuits are included to generate a logic signal to perform the writing operation of the pixel circuit 14. The data signal driven by the data line drive circuit 12 is input through the data line 15 to perform the writing operation of a pixel in the row to be written by the gate line drive circuit 13.

FIG. 1B is a partial cross-sectional view of a portion equivalent to a pixel (for example, a-th row and b-th column in FIG. 1A) in the display apparatus of the present invention. The pixel of the display apparatus of the present invention includes a plurality of sub-pixels. The “sub-pixel” denotes an area including one light emitting element. Although FIG. 1B illustrates a top-emission display apparatus that extracts light from the upper surface (from the upper direction) of the organic EL element formed on the substrate, the present invention can also be applied to a bottom-emission display apparatus.

The organic EL element as a light emitting element is formed on each of the plurality of sub-pixels in the present invention, and the viewing angle characteristics (viewing angle characteristics A and viewing angle characteristics B) of the plurality of sub-pixels included in the same pixel are different. Specifically, each pixel includes two sub-pixels that emit light of the same color, and an element with high light-collecting property is disposed over the light emission side of the organic EL element arranged on one of the two sub-pixels. An example of the element with high light-collecting property includes a microlens. Alternatively, the distance between a pair of electrodes may be changed, and one of organic EL elements A and B may have a constructive interference effect in the front direction. The other element may have a constructive interference effect in an oblique direction (direction other than the front side).

An area separation layer 22 that separates areas is arranged between the organic EL elements in different areas. Each organic EL element includes an anode electrode and a cathode electrode 24 that form a pair of electrodes as well as an organic compound layer 23 (hereinafter, called “organic EL layer”) that is placed between the electrodes and that includes an emission layer. Specifically, the anode electrode 21 patterned for each organic EL element is formed over the substrate 20, the organic EL layer 23 is formed over the anode electrode 21, and the cathode electrode 24 is formed over the organic EL layer 23.

The anode electrode 21 is formed by a conductive metallic material with high reflectance, such as Ag. Alternatively, the anode electrode 21 may be formed by a laminated body including a layer made of such a metallic material and a layer made of a transparent conductive material, such as ITO (Indium-Tin-Oxide) with excellent hole injection characteristics.

The cathode electrode 24 is commonly formed for a plurality of organic EL elements and has a semi-reflective or light-transmissive configuration that allows taking the light emitted by the emission layer out of the elements. Specifically, when the cathode electrode 24 has a semi-reflective configuration to improve the interference effect inside the elements, the cathode electrode 24 is formed by a layer with a thickness of 2 to 50 nm that is made of a conductive metallic material with excellent electron injection property, such as Ag and AgMg. The “semi-reflective” denotes a property of reflecting part of the light emitted inside the elements and transmitting part of the light, and the reflectance is 20 to 80% relative to the visible light. The “light-transmissive” denotes a transparency of 80% or more relative to the visible light.

The organic EL layer 23 includes one or a plurality of layers including at least an emission layer. Examples of configuration of the organic EL layer 23 include a four-layer configuration including a hole transport layer, an emission layer, an electron transport layer, and an electron injection layer and a three-layer configuration including a hole transport layer, an emission layer, and an electron transport layer. Known materials can be used to form the organic EL layer 23.

A pixel circuit is formed on the substrate 20 to independently drive the organic EL elements. The pixel circuit includes a plurality of thin film transistors not illustrated (hereinafter, called “TFT”). The substrate 20 provided with the TFTs is covered by an interlayer insulation film provided with a contact hole for electrically connecting the TFTs and the anode electrode 21 (not illustrated). A planarized passivation film is formed over the interlayer insulation film to absorb the surface irregularity formed by the pixel circuit to planarize the surface (not illustrated).

A protective layer 25 is formed over the cathode electrode 24 to protect the organic EL layer 23 from oxygen or moisture in the air. The protective layer 25 is made of inorganic materials such as SiN and SiON. Alternatively, the protective layer 25 is made of laminated layers of inorganic materials and organic materials. The thickness of the inorganic film can be 0.1 μm or more and 10 μm or less and can be formed by a CVD method. The organic film can be 1 μm or more to be used to improve the protection performance by covering foreign materials that are attached on the surface during processing and cannot be removed. Although the protective layer 25 is formed along the shape of the pixel separation layer 22 in FIG. 1B, the surface of the protective layer 25 can be flat. The surface can be easily flattened using organic materials.

The display apparatus of the present invention may be an organic EL panel with three different hues or may be an organic EL panel with four different hues instead of three hues. In the case of three hues, for example, the organic EL panel may include R, G, and B three hues, and organic EL elements of R, G, and B three hues may be included. Color filters of R, G, and B three hues may be placed on top of a white organic EL element. In this case, a pixel unit including pixels for displaying R, G, and B hues serves as a display unit. In the case of four hues, for example, the organic EL panel may include R, G, B, and W four hues.

FIG. 1C illustrates an example of a pixel arrangement of the organic EL panel of the present invention. An R pixel 31, a G pixel 32, and a B pixel 33 are arranged on the organic EL panel, and the R pixel 31, the G pixel 32, and the B pixel 33 form one pixel unit. The R pixel 31 includes an R-1 sub-pixel 311 and an R-2 sub-pixel 312. The hue of the sub-pixels is R, and the optical characteristics of the sub-pixels are different. The G pixel 32 includes a G-1 sub-pixel 321 and a G-2 sub-pixel 322. The hue of the sub-pixels is G, and the optical characteristics of the sub-pixels are different. The B pixel 33 includes a B-1 sub-pixel 331 and a B-2 sub-pixel 332. The hue of the sub-pixels is B, and the optical characteristics of the sub-pixels are different. There are pixels including two sub-pixels that emit R and that have different optical characteristics, pixels including two sub-pixels that emit G and that have different optical characteristics, and pixels including two sub-pixels that emit B and that have different optical characteristics.

In the following description, the R-1 sub-pixel 311, the G-1 sub-pixel 321, and the B-1 sub-pixel 331 form sub-pixels A with wide viewing angle characteristics. The R-2 sub-pixel 312, the G-2 sub-pixel 322, and the B-2 sub-pixel 332 form sub-pixels B with high front luminance characteristics. The high front luminance characteristics denote characteristics of high light extraction efficiency in the front direction, i.e. the normal direction of the substrate.

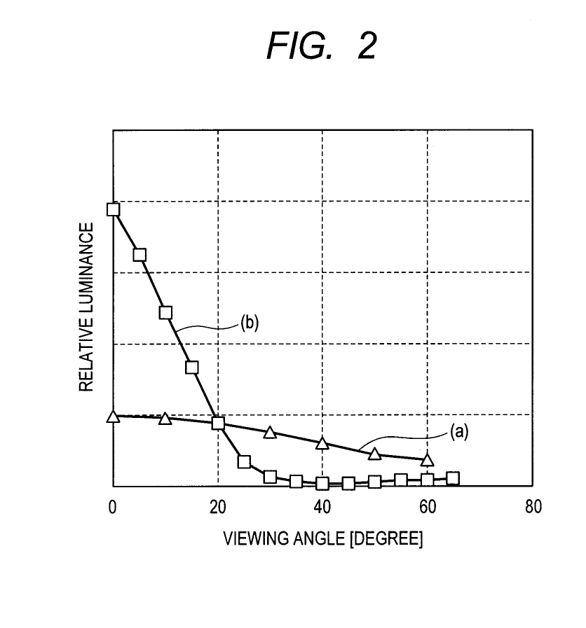

FIG. 2 illustrates relative luminance to viewing angle characteristics of the sub-pixels A and B. In FIG. 2, (a) denotes relative luminance to viewing angle characteristics of the sub-pixel A, and (b) denotes relative luminance to viewing angle characteristics of the sub-pixel B. The luminance is expressed by relative luminance values when the same current is injected to the sub-pixels A and B, and the front luminance of the sub-pixel A is assumed to be 1. According to FIG. 2, the viewing angle of the sub-pixel A is wide. On the other hand, the viewing angle of the sub-pixel B is narrow, but the front luminance is four times that of the sub-pixel A.

An operation of the organic EL panel 11 will be described. A pixel circuit that can independently select lighting and lights-out (emission and non-emission) drives two sub-pixels with different optical characteristics of each of the R, G, and B pixels. For example, the R-1 sub-pixel and the R-2 sub-pixel can be independently lit and lit out in the R pixel.

The drive by the following three modes allows the display according to the user scene, and high image quality can be realized.

The organic EL panel 11 can obtain performance of wide viewing angle when only the R-1 sub-pixel 311, the G-1 sub-pixel 321, and the B-1 sub-pixel 331 that are areas with optical characteristics of wide viewing angle are lit (hereinafter, called “wide viewing angle mode”).

The organic EL panel 11 can obtain performance of high front luminance when only the R-2 sub-pixel 312, the G-2 sub-pixel 322, and the B-2 sub-pixel 332 that are areas with narrow viewing angle and with optical characteristics of high front luminance are lit (hereinafter, called “outdoor visibility mode”).

The power consumption can be reduced when the R-2 sub-pixel 312, the G-2 sub-pixel 322, and the B-2 sub-pixel 332 are lit at a low current and when the front luminance is made equivalent to when the R-1 sub-pixel 311, the G-1 sub-pixel 321, and the B-1 sub-pixel 331 are lit (hereinafter, called “power saving mode”).

When the sub-pixels A and B are lit in intermediate states between the “wide viewing angle mode” and the “outdoor visibility mode” and intermediate states between the “wide viewing angle mode” and the “power saving mode”, more various displays are possible according to the user scene, and high image quality can be realized.

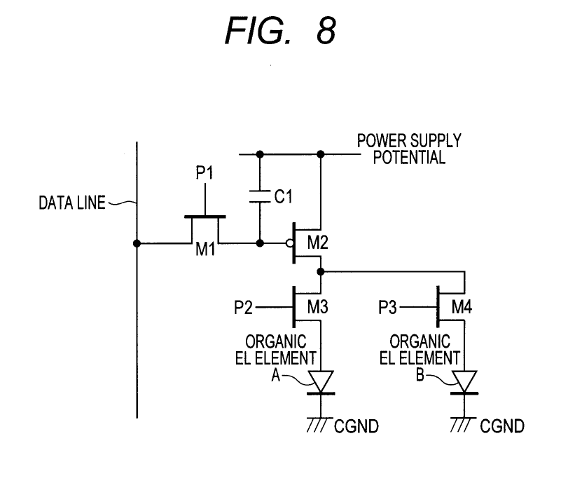

Examples of the pixel circuit that is driven in the three modes include pixel circuits in FIGS. 8, 11, and 14. In any of the three modes, two sub-pixels of the same color and with different optical characteristics are driven based on common image data, and it is also possible to make a difference in lighting times or driving currents between the two sub-pixels with different optical characteristics. The lighting time and the drive current of the sub-pixels are changed according to the optical characteristics based on the relative characteristics between the front luminance and the peripheral luminance and according to the three modes. The present invention includes units that make a difference in lighting times or drive currents between the organic EL elements A and B of the same color for the display according to the user scene.

Hereinafter, although details will be described in specific embodiments, the present invention is not limited to the following three embodiments.

### First Embodiment

The display apparatus of the present embodiment includes the organic EL panel of FIG. 1A, the pixel configuration of FIG. 1B, and the pixel arrangement of FIG. 1C. The R-1 sub-pixel 311, the G-1 sub-pixel 321, and the B-1 sub-pixel 331 of FIG. 1C are formed by the sub-pixels A with wide viewing angle characteristics, and the R-2 sub-pixel 312, the G-2 sub-pixel 322, and the B-2 sub-pixel 332 are formed by the sub-pixels B with high front luminance characteristics. For example, the surfaces of the sub-pixels including the organic EL elements A can be flat, and elements with high light-collecting property, such as microlenses, can be formed on the sub-pixels including the organic EL elements B. The relative luminance to viewing angle characteristics between the sub-pixels including the organic EL elements A and the sub-pixels including the organic EL elements B are as illustrated in FIG. 2. An example of the pixel circuit includes the pixel circuit of FIG. 8.

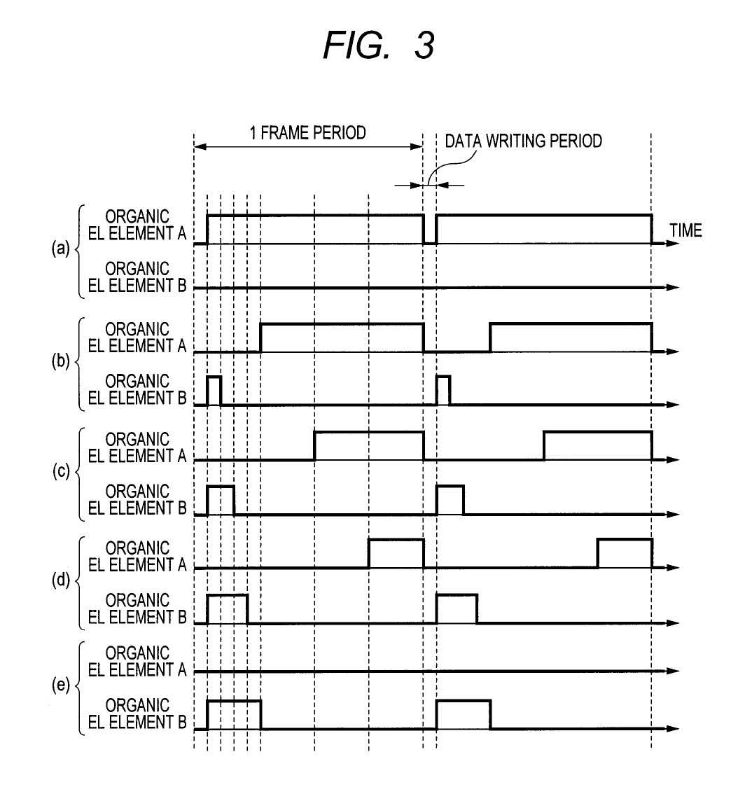

In the present embodiment, the drive currents are the same, and the lighting times are different in the organic EL elements A and B of the same color. Specifically, the data line 15 of FIG. 1A writes the same signal in the organic EL elements A and B of the same color, and the lighting times in the organic EL elements A and B of the same color are different in the pixel circuits. Examples of the units that make a difference in lighting times between the organic EL elements A and B of the same color in the pixel circuits include units that are separately disposed the organic EL elements A and B of the same color and that separately controls lighting and lights-out of the organic EL elements A and B of the same color. Examples of the unit include P2 and TFT (M3) as well as P3 and TFT (M4) in FIG. 8. Hereinafter, the present embodiment will be described with reference to FIG. 3.

FIG. 3 is an operation timing chart of the modes of the organic EL panel of the present embodiment. In FIG. 3, the horizontal axis denotes time, and the vertical axis denotes ON (HI) and OFF (LOW) of the lighting. It is assumed that the front luminance of the sub-pixels including the organic EL elements A (a): the front luminance of the sub-pixels including the organic EL elements B (b)=1:4 in FIG. 2, and the relationship between the peripheral luminance and the power is set as a setting condition. The setting condition is as follows.

In a case in which the “wide viewing angle mode” and the “power saving mode” can be selected will be described. The front luminance of the sub-pixels including the organic EL elements A and the front luminance of the sub-pixels including the organic EL elements B are the same in realizing the two modes. In five modes illustrated in FIG. 3, it is assumed that the power ratio per frame of the modes is (a):(b):(c):(d):(e)=16:13:10:7:4. In this case, (lighting time of organic EL elements A):(lighting time of organic EL elements B)=16:0 in (a), 12:1 in (b), 8:2 in (c), 4:3 in (d), and 0:4 in (e). The ratio of current-time product of the organic EL elements A and the organic EL elements B per frame is 4:0 in (a), 3:1 in (b), 2:2 in (c), 1:3 in (d), and 0:4 in (e). The drive current input from the pixel circuit is the same current at any lighting timing.

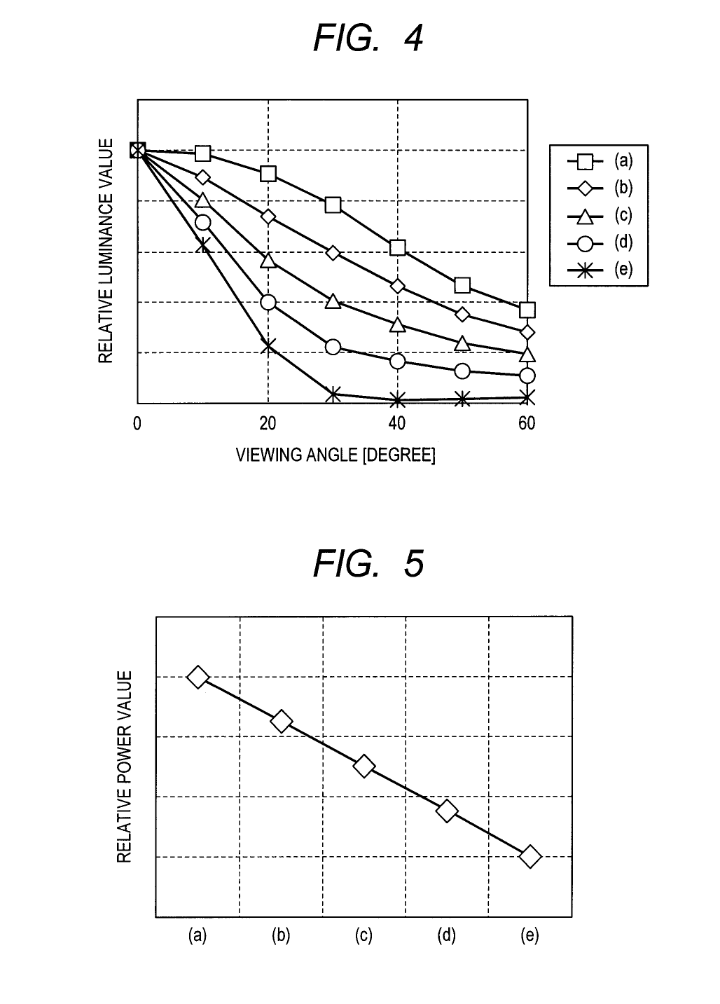

FIG. 4 illustrates the relative luminance to viewing angle characteristics, and FIG. 5 illustrates the relative power characteristics when the elements are lit in this way. In FIGS. 4 and 5, (a) to (e) correspond to (a) to (e) of FIG. 3. It can be recognized from FIG. 4 that the viewing angle increases as viewed from (e) to (a). It can be recognized from FIG. 5 that the power consumption can be reduced as viewed from (a) to (e). Therefore, the “wide viewing angle mode” can be selected by lighting the elements as in (a), and the “power saving mode” can be selected by lighting the elements as in (e). Intermediate states between the “wide viewing angle mode” and the “power saving mode” can be selected by lighting the elements as in (b) to (d). Therefore, high image quality can be realized.

A case in which the “wide viewing angle mode” and the “outdoor visibility mode” can be selected will be described. The front luminance of the sub-pixels including the organic EL elements A and the front luminance of the sub-pixels including the organic EL elements B are not the same in realizing the two modes. It is assumed that the power ratio per frame of five modes is (a):(b):(c):(d):(e)=4:7:10:13:16. In this case, (lighting time of organic EL elements A): (lighting time of organic EL elements B)=4:0 in (a), 3:4 in (b), 2:8 in (c), 1:12 in (d), and 0:16 in (e). The ratio of current-time product of the organic EL elements A and the organic EL elements B per frame is 4:0 in (a), 3:1 in (b), 2:2 in (c), 1:3 in (d), and 0:4 in (e).

When the elements are lit in this way, the viewing angle increases as viewed from (e) to (a), and the front luminance increases as viewed from (a) to (e). Therefore, the “wide viewing angle mode” can be selected by lighting the elements as in (a), and the “outdoor visibility mode” can be selected by lighting the elements as in (e). Intermediate states between the “wide viewing angle mode” and the “outdoor visibility mode” can also be selected by lighting the elements as in (b) to (d). Therefore, high image quality can be realized.

The number of times of writing in the same data line in the organic EL elements A and B of the same color can be one in the present embodiment. Therefore, the layout efficiency can be improved by simplified peripheral circuits, common wiring, etc. Substantially the same dynamic ranges of the signal level of the data line 15 can be secured for the organic EL elements A and B of the same color, and the S/N ratio can be increased.

### Second Embodiment

The display apparatus of the present embodiment is the same as in the first embodiment, except that the pixel circuit is different. An example of the pixel circuit includes the pixel circuit of FIG. 11.

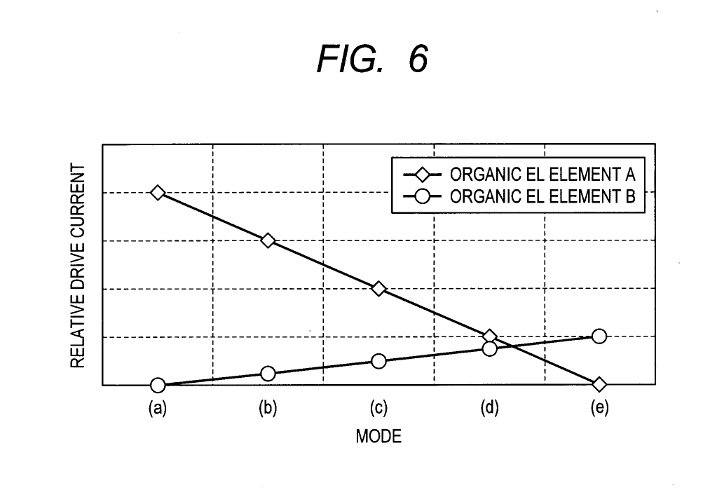

The present embodiment is different from the first embodiment in that the lighting times are the same in the organic EL elements A and B of the same color, and the drive currents are different. Specifically, the data line drive circuit 12 of FIG. 1A generates data signals for the organic EL elements A and B of the same color, and different signals are written in the data line 15 to supply different drive currents to the organic EL elements A and B of the same color. Units that supply different drive currents to the organic EL elements A and B of the same color in the data line drive circuit 12 (in the data line driver) can be units that generate and supply different data signals to the gate terminals of the drive transistors included in the organic EL elements A and B of the same color. The operation timing chart of the organic EL panel of the present embodiment will be illustrated in Example 2. Hereinafter, the present embodiment will be described with reference to FIG. 6.

FIG. 6 illustrates relative drive current characteristics of the modes of the organic EL panel of the present embodiment. In FIG. 6, the horizontal axis denotes the modes, and the vertical axis denotes the relative drive currents of the organic EL elements A and B. It is assumed that the front luminance of the sub-pixels including the organic EL elements A (a): the front luminance of the sub-pixels including the organic EL elements B (b)=1:4 in FIG. 2, and the relationship between the peripheral luminance and the power is set as a setting condition. The setting condition is as follows.

A case in which the “wide viewing angle mode” and the “power saving mode” can be selected will be described. As described, the front luminance of the sub-pixels including the organic EL elements A and the front luminance of the sub-pixels including the organic EL elements B are the same in realizing the two modes. In five modes illustrated in FIG. 6, it is assumed that the power ratio per frame of the modes is (a):(b):(c):(d):(e)=16:13:10:7:4. In this case, (drive current of organic EL elements A):(drive current of organic EL elements B)=16:0 in (a), 12:1 in (b), 8:2 in (c), 4:3 in (d), and 0:4 in (e). The ratios of current-time product per frame of the organic EL elements A and the organic EL elements B are 4:0 in (a), 3:1 in (b), 2:2 in (c), 1:3 in (d), and 0:4 in (e).

When the elements are lit in this way, the relative luminance to viewing angle characteristics and the relative power characteristics are as illustrated in FIGS. 4 and 5, respectively. In FIGS. 4 and 5, (a) to (e) correspond to (a) to (e) of FIG. 6. As in the first embodiment, the viewing angle increases as viewed from (e) to (a), and the power consumption can be reduced as viewed from (a) to (e). Therefore, the “wide viewing angle mode” and the “power saving mode” can be selected as in the first embodiment, and intermediate states between the “wide viewing angle mode” and the “power saving mode” can also be selected. Therefore, high image quality can be realized.

A case in which the “wide viewing angle mode” and the “outdoor visibility mode” can be selected will be described. As described, the front luminance of the sub-pixels including the organic EL elements A and the front luminance of the sub-pixels including the organic EL elements B are not the same in realizing the two modes. It is assumed that the power ratio per frame of five modes is (a):(b):(c):(d):(e)=4:7:10:13:16. In this case, (drive current of organic EL elements A):(drive current of organic EL elements B)=4:0 in (a), 3:4 in (b), 2:8 in (c), 1:12 in (d), and 0:16 in (e). The ratios of current-time product per frame of the organic EL elements A and the organic EL elements B are 4:0 in (a), 3:1 in (b), 2:2 in (c), 1:3 in (d), and 0:4 in (e).

When the elements are lit in this way, the viewing angle increases as viewed from (e) to (a), and the front luminance increases as viewed from (a) to (e) as in the first embodiment. Therefore, as in the first embodiment, the “wide viewing angle mode” and the “outdoor visibility mode” can be selected, and intermediate states between the “wide viewing angle mode” and the “outdoor visibility mode” can be selected. Therefore, high image quality can be realized.

The data line drive circuit 12 can set detailed drive conditions in the modes in the present embodiment. Therefore, the drive with higher usability is possible. Gamma characteristics, etc., of the organic EL elements A and B of the same color can be easily corrected, and high-quality drive is possible.

### Third Embodiment

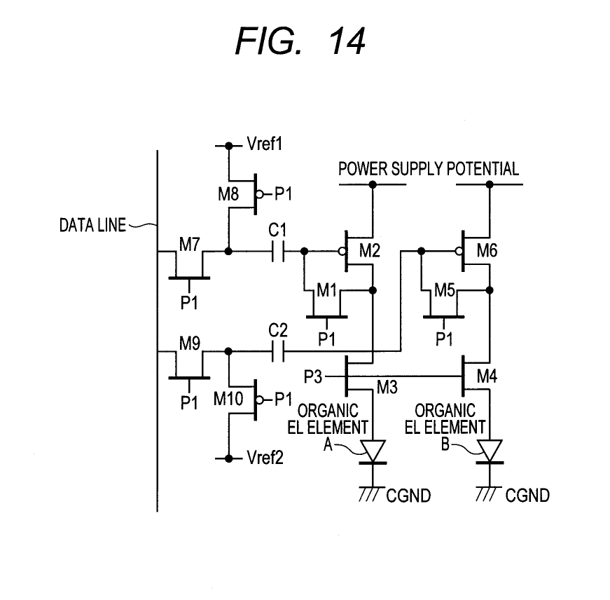

The display apparatus of the present embodiment is the same as in the second embodiment, except that the pixel circuit is different. An example of the pixel circuit includes the pixel circuit of FIG. 14.

The present embodiment is the same as the second embodiment in that the lighting times are the same, and the drive currents are different in the organic EL elements A and B of the same color. However, the present embodiment is different from the second embodiment in that the data line 15 of FIG. 1A writes the same data signal in the organic EL elements A and B of the same color, and different drive currents are supplied to the organic EL elements A and B of the same color in each pixel circuit. Units that supply different drive currents to the organic EL elements A and B of the same color in each pixel circuit can be units that supply different voltages (reference voltages) to the gate terminals of the drive transistors included in the organic EL elements A and B of the same color. Examples of the units include voltages Vref1 and Vref2 applied to the gate terminal of a TFT (M2) and to the gate terminal of a TFT (M6) that are drive TFTs in FIG. 14. The operation timing chart of the organic EL panel of the present embodiment will be illustrated in Example 3. Hereinafter, the present embodiment will be described.

The relative drive current characteristics of the modes of the organic EL panel in the present embodiment are as illustrated in FIG. 6. It is assumed that the front luminance of the sub-pixels including the organic EL elements A (a):the front luminance of the sub-pixels including the organic EL elements B (b)=1:4 in FIG. 2, and the relationship between the peripheral luminance and the power is set as a setting condition. The setting condition is as follows.

A case in which the “wide viewing angle mode” and the “power saving mode” can be selected will be described. As in the second embodiment, it is assumed that the power ratio per frame of five modes is 16:13:10:7:4. In this case, the drive current ratios of the organic EL elements A and B are 16:0 in (a), 12:1 in (b), 8:2 in (c), 4:3 in (d), and 0:4 in (e). The ratios of current-time product of the organic EL elements A and the organic EL elements B per frame are 4:0 in (a), 3:1 in (b), 2:2 in (c), 1:3 in (d), and 0:4 in (e).

When the elements are lit in this way, the viewing angle increases as viewed from (e) to (a), and the power consumption can be reduced as viewed from (a) to (e) as in the second embodiment. Therefore, as in the second embodiment, the “wide viewing angle mode” and the “power saving mode” can be selected, and intermediate states between the “wide viewing angle mode” and the “power saving mode” can be selected. Therefore, high image quality can be realized.

A setting condition when the “wide viewing angle mode” and the “outdoor visibility mode” can be selected will be described. As in the second embodiment, it is assumed that the power ratio per frame of five modes is 4:7:10:13:16. In this case, the drive current ratios of the organic EL elements A and B are 4:0 in (a), 3:4 in (b), 2:8 in (c), 1:12 in (d), and 0:16 in (e). The ratios of current-time product of the organic EL elements A and the organic EL elements B per frame are 4:0 (a), 3:1 in (b), 2:2 in (c), 1:3 in (d), and 0:4 in (e).

When the elements are lit in this way, the viewing angle increases as viewed from (e) to (a), and the front luminance increases as viewed from (a) to (e) as in the second embodiment. Therefore, as in the second embodiment, the “wide viewing angle mode” and the “outdoor visibility mode” can be selected, and intermediate states between the “wide viewing angle mode” and the “outdoor visibility mode” can be selected. Therefore, high image quality can be realized.

As in the first embodiment, the layout efficiency can be improved by simplified peripheral circuits and common wiring, etc., and the S/N ratio can be increased in the present embodiment.

Although there are five steps of (a) to (e) in switching of the modes as in FIGS. 3 and 6 in the three embodiments, the resolving power may be increased, or (a) to (e) may be steplessly changed.

Hereinafter, the present invention will be described in detail with Examples.

### Example 1

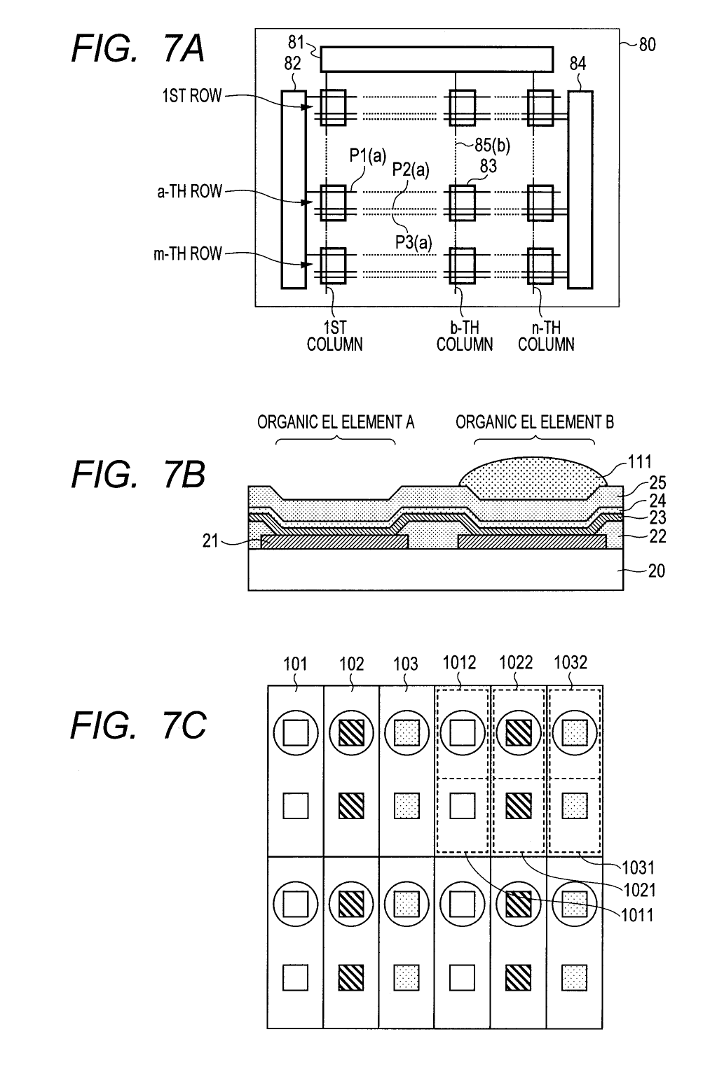

FIG. 7A is a schematic diagram of an organic EL panel 80 that has a plurality of pixels (pixels of m rows and n columns) arranged in a matrix and that includes organic EL elements arranged on each pixel. The organic EL panel 80 is an organic EL panel of the present Example. The organic EL panel 80 includes an organic EL element not illustrated, a data line drive circuit 81 (data line driver), a gate line drive circuit 82 (gate line driver), a pixel circuit 83, and a gate line drive circuit 84 (gate line driver). The data line drive circuit 81 applies a data signal to a data line 85. The gate line drive circuit 82 drives a gate line P1. The pixel circuit 83 is arranged on each pixel, includes a plurality of transistors, and supplies a drive current according to the data signal to the organic EL element to light the organic EL element. The gate line drive circuit 84 drives gate lines (selection control lines) P2 and P3 of the display area. There are pixels including two sub-pixels that emit R and that have different optical characteristics, pixels including two sub-pixels that emit G and that have different optical characteristics, and pixels including two sub-pixels that emit B and that have different optical characteristics. Each sub-pixel includes an organic EL element. Although the gate line drive circuit 82 and the gate line drive circuit 84 of the display area are arranged on the left and right sides across the pixel group in FIG. 7A, the circuits may be arranged on one of the left and right sides, or the circuits may drive from both sides by arranging the same functions on the left and right sides to improve the quality of the writing operation of the pixels.

FIG. 7B is a partial cross-sectional view illustrating a portion equivalent to a pixel in the display apparatus of the present Example. The layers below the protective layer 25 have the same configurations as in FIG. 1B. The surface of the sub-pixel including the organic EL element A is flat, and a microlens 111 is formed on the sub-pixel including the organic EL element B. The microlens 111 is formed by processing a resin material, and specifically, the microlens 111 can be formed by a method such as embossing.

In the sub-pixel without a microlens, the light obliquely emitted from the emission layer of the organic EL layer 23 is further obliquely emitted when the light is emitted from the protective layer 25, or the light is totally reflected and cannot be extracted outside. On the other hand, in the sub-pixel with the microlens 111, the light emitted from the emission layer of the organic EL layer 23 is transmitted through the transparent cathode electrode 24 and is emitted outside after transmitting through the protective layer 25 and the microlens 111.

When there is the microlens 111, the emission angle approaches the normal direction of the substrate compared to when there is no microlens. Therefore, the light-collecting effect in the normal direction of the substrate improves when there is the microlens 111. Therefore, the light utilization efficiency in the front direction can be improved in the display apparatus. When there is the microlens 111, the incident angle of the light obliquely emitted from the emission layer relative to the emission interface is close to perpendicular, and the amount of totally reflected light is reduced. As a result, the light extraction efficiency also improves.

In this way, the organic EL panel 80 of the present Example has a sub-pixel in which the light emission side of the organic EL element is flat and a sub-pixel including a microlens formed on the light emission side of the organic EL element (the side of extracting the light, the upper side of a top-emission organic EL element). The sub-pixel including the organic EL element A has optical characteristics of wide viewing angle, because there is no microlens. The sub-pixel including the organic EL element B has optical characteristics of high front luminance, because there is a microlens.

FIG. 7C illustrates a pixel arrangement of an organic EL panel of the present Example. An R pixel 101, a G pixel 102, and a B pixel 103 are arranged in the organic EL panel, and the R pixel 101, the G pixel 102, and the B pixel 103 form one pixel unit. The R pixel 101 is formed by an R-1 sub-pixel 1011 and an R-2 sub-pixel 1012. The G pixel 102 is formed by a G-1 sub-pixel 1021 and a G-2 sub-pixel 1022. The B pixel 103 is formed by a B-1 sub-pixel 1031 and a B-2 sub-pixel 1032. The R-1 sub-pixel 1011, the G-1 sub-pixel 1021, and the B-1 sub-pixel 1031 are sub-pixels in which the light emission sides are flat. The R-2 sub-pixel 1012, the G-2 sub-pixel 1022, and the B-2 sub-pixel 1032 are sub-pixels in which the microlenses are formed on the light emission sides of the organic EL elements. The relative luminance to viewing angle characteristics in the R-1 sub-pixel 1011, the G-1 sub-pixel 1021, and the B-1 sub-pixel 1031 and the relative luminance to viewing angle characteristics in the R-2 sub-pixel 1012, the G-2 sub-pixel 1022, and the B-2 sub-pixel 1032 are as in (a) and (b) of FIG. 2, respectively.

FIG. 8 illustrates a pixel circuit of the present Example. The gate line P1 is connected to the gate terminal of the TFT (M1). The selection control line P2 of the organic EL element A is connected to the gate terminal of the TFT (M3). The selection control line P3 of the organic EL element B is connected to the gate terminal of the TFT (M4). The data line is connected to the drain terminal of the TFT (M1), and voltage data Vdata is input from the data line as a data signal. The anode electrode of the organic EL element A is connected to the source terminal of the TFT (M3), and the cathode electrode is connected to a ground potential CGND. The anode electrode of the organic EL element B is connected to the source terminal of the TFT (M4), and the cathode electrode is connected to the ground potential CGND. The drain terminal of the TFT (M3) is connected to the drain terminal of the TFT (M2), and the source terminal of the TFT (M2) is connected to a power supply potential. The drain terminal of the TFT (M4) is connected to the drain terminal of the TFT (M2). The source terminal of the TFT (M1) is connected to one end of the capacity C1 and the gate terminal of the TFT (M2). The other end of the capacity C1 is connected to the power supply potential.

In the present Example, the same data signal is applied to the data line 85 of FIG. 7A in the organic EL elements A and B of the same color, and difference is made in lighting times between the organic EL elements A and B of the same color in each pixel circuit. The units that make a difference in lighting times between the organic EL elements A and B of the same color in each pixel circuit are P2 and M3 as well as P3 and M4 in FIG. 8.

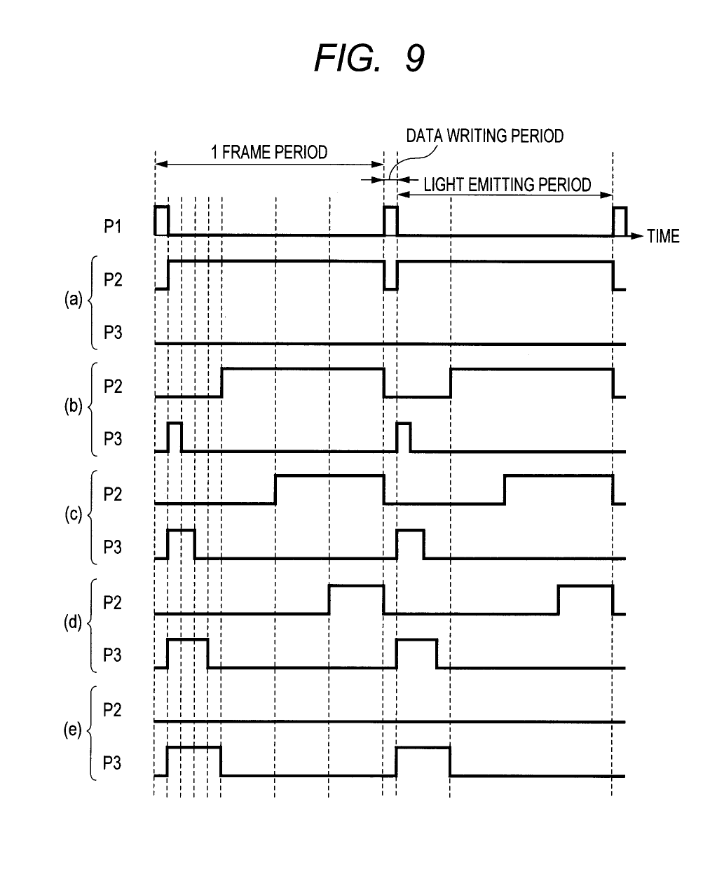

An operation of the pixel circuit of FIG. 8 will be described with reference to a timing chart of FIG. 9. In FIG. 9, the horizontal axis denotes time, and the vertical axis denotes ON (HI) and OFF (LOW) of P1 to P3. P2 and P3 are signals for controlling the light emission of the organic EL elements A and B.

A data writing period in FIG. 9 will be described.

In the period, a HI level signal is input to P1, and a LOW level signal is input to P2 and P3. M1 is turned on, and M3 and M4 are turned off. In this case, M3 and M4 are not conducted, and a current does not flow through the organic EL elements A and B. A voltage according to the current driving ability of M1 is generated at C1 arranged between the gate terminal of M2 and a power supply potential V1 based on Vdata. More specifically, a data signal is written (Vdata is input). Although a case in which M1, M3, and M4 are nMOSs, and M2 is a pMOS is described, the HI and LOW levels need to be opposite if M1, M3, and M4 are pMOSs.

A light emitting period in FIG. 9 will be described.

When a current is supplied to the organic EL element A, a LOW level signal is input to P1, a HI level signal is input to P2, and a LOW level signal is input to P3. M1 is turned off, M3 is turned on, and M4 is turned off. In this case, since M3 is conducted, a current according to the current driving ability of M2 is supplied to the organic EL element A based on the voltage generated in C1, and the organic EL element A emits light at luminance according to the supplied current. The organic EL element A emits light when P2 is in the HI level, and the integrated light is the luminance of the organic EL element A.

When a current is supplied to the organic EL element B, a LOW level signal is input to P1, a LOW level signal is input to P2, and a HI level signal is input to P3. M1 is turned off, M3 is turned off, and M4 is turned on. In this case, since M4 is conducted, a current according to the current driving ability of M2 is supplied to the organic EL element B based on the voltage generated at C1, and the organic EL element B emits light at luminance according to the supplied current. The organic EL element B emits light when P3 is in the HI level, and the integrated light is the luminance of the organic EL element B.

In the present Example, based on the microlens disposed over the light emission side of the organic EL element B, the front luminance of the sub-pixels including the organic EL elements A:the front luminance of the sub-pixels including the organic EL elements B=1:4 when the same current is supplied to the organic EL elements A and B for light emission. In this case, the ratios of current-time product per frame of the organic EL elements A and the organic EL elements B=4:0, 3:1, 2:2, 1:3, and 0:4 (see (a) to (e) of FIG. 9). The ratio of front luminance and the ratios of current-time product are taken into account to set the lighting times of the organic EL elements A and the organic EL elements B.

A case in which the “wide viewing angle mode” and the “power saving mode” can be selected will be described. Based on the ratio of front luminance and the ratios of current-time product, there are five lighting time ratios of 16:0, 12:1, 8:2, 4:3, and 0:4 for the organic EL elements A and B. The present Example includes units that are separately connected to each of the two organic EL elements that emit light of the same color, and the units separately control lighting and lights-out of each of the two organic EL elements. Therefore, ON and OFF of M3 and M4 can be set to satisfy the five lighting time ratios. When the elements are lit in this way, the “wide viewing angle mode” and the “power saving mode” can be selected, and intermediate states between the “wide viewing angle mode” and the “power saving mode” can also be selected as described in the first embodiment. Therefore, high image quality can be realized.

A case in which the “wide viewing angle mode” and the “outdoor visibility mode” can be selected will be described. Based on the ratio of front luminance and the ratios of current-time product, there are five lighting time ratios of 4:0, 3:4, 2:8, 1:12, and 0:16 for the organic EL elements A and B. The present Example includes units separately connected to each of the two organic EL elements that emit light of the same color, and the units separately control lighting and lights-out of each of the two organic EL elements. Therefore, ON and OFF of M3 and M4 can be set to satisfy the five lighting time ratios. When the elements are lit in this way, the “wide viewing angle mode” and the “outdoor visibility mode” can be selected, and intermediate states of the “wide viewing angle mode” and the “outdoor visibility mode” can also be selected as described in the first embodiment. Therefore, high image quality can be realized.

Since the instantaneous current input to light the organic EL elements A and B is constant in the present Example, the pixel circuit can drive the organic EL elements A and B at the same current value. Specifically, the input data signals can be the same values when only one of the organic EL elements A and B emits light as in (a) and (e) of FIG. 9. Therefore, the dynamic range of the data signal supplied to the organic EL element B can be wide, and the S/N ratio can be increased. The current values can be the same values in the drives of (b) to (d) of FIG. 9. Therefore, both the organic EL elements A and B can be driven based on only one writing of the data signals of the pixel circuit.

### Example 2

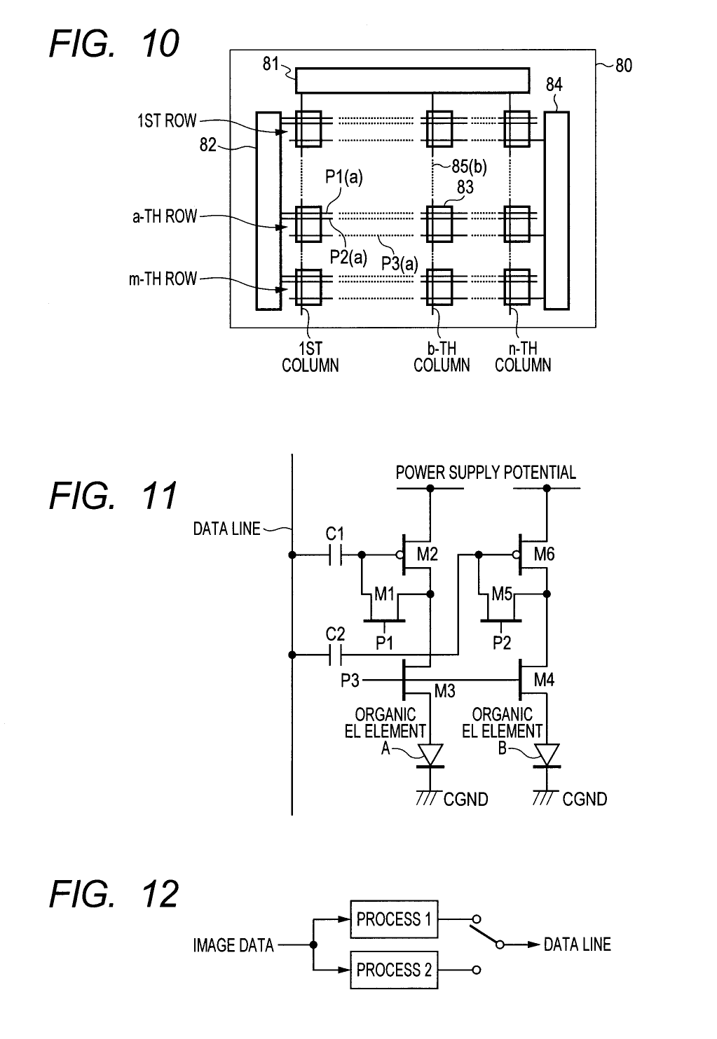

FIG. 10 is a schematic diagram of the organic EL panel 80 that includes a plurality of pixels (pixels of m rows and n columns) arranged in a matrix and that includes organic EL elements arranged on each pixel. The organic EL panel 80 is an organic EL panel of the present Example. The organic EL panel 80 includes the organic EL element not illustrated, the data line drive circuit 81 (data line driver), the gate line drive circuit 82 (gate line driver), the pixel circuit 83, and the gate line drive circuit 84 (gate line driver). The data line drive circuit 81 applies a data signal to the data line 85. The gate line drive circuit 82 drives the gate lines P1 and P2. The pixel circuit 83 is arranged on each pixel, includes a plurality of transistors, and supplies a drive current according to the data signal to the organic EL element to light the organic EL element. The gate line drive circuit 84 drives the gate line (selection control line) P3 of the display area. There are pixels including two sub-pixels that emit R and that have different optical characteristics, pixels including two sub-pixels that emit G and that have different optical characteristics, and pixels including two sub-pixels that emit B and that have different optical characteristics. Each sub-pixel includes an organic EL element. Although the gate line drive circuit 82 and the gate line drive circuit 84 of the display area are arranged on the left and right sides across the pixel group in FIG. 10, the circuits may be arranged on one of the left and right sides, or the circuits may be driven from both sides by arranging the same functions on both the left and right sides to improve the quality of the writing operation of the pixels. The pixel configuration and the pixel arrangement of the display apparatus of the present Example are the same as in FIGS. 7B and 7C, and the description will not be repeated.

FIG. 11 illustrates a pixel circuit of the present Example. The gate lines P1 and P2 are connected to the gate terminal of the TFT (M1) and the gate terminal of a TFT (M5), respectively. The selection control lines P3 of both the organic EL elements A and B are connected to the gate terminal of the TFT (M3) and the gate terminal of the TFT (M4). The data line is connected to one end of the capacity C1 and to one end of a capacity C2. The voltage data Vdata is input from the data line as a data signal. Different data signals V1 and V2 generated by the data line drive circuit 81 of FIG. 10 are supplied from the data line to the one end of the capacity C1 and the one end of the capacity C2. The anode electrode of the organic EL element A is connected to the source terminal of the TFT (M3), and the cathode electrode is connected to the ground potential CGND. The anode electrode of the organic EL element B is connected to the source terminal of the TFT (M4), and the cathode electrode is connected to the ground potential CGND. The drain terminal of the TFT (M3) is connected to the source terminal of the TFT (M1) and the drain terminal of the TFT (M2), and the source terminal of the TFT (M2) is connected to the power supply potential. The drain terminal of the TFT (M4) is connected to the source terminal of the TFT (M5) and the drain terminal of a TFT (M6), and the source terminal of the TFT (M6) is connected to the power supply potential. The drain terminal of the TFT (M1) is connected to the gate terminal of the TFT (M2) and to the other end of the capacity C1, and the drain terminal of the TFT (M5) is connected to the gate terminal of the TFT (M6) and to the other end of the capacity C2.

A unit that generates different data signals Vdata=V1, V2 in the data line drive circuit 81 of FIG. 10 will be described. Two processing blocks can be prepared as the unit that generates different data signals. FIG. 12 illustrates an example of configuration of the unit that generates two data signals from one image data. When the image data is input to the two processing blocks, for example, a block of a process 1 processes the data into data for the organic EL element A to generate a data signal, and a block of a process 2 processes the data into data for the organic EL element B to generate a data signal. In the processing blocks, the data signals may be generated by analog processing by a resistance ladder circuit in which the resistance ratio is changed for the organic EL element or for the organic EL element B, or a DA converter may generate the data signals from data after digital signal processing. The generated data signal for the organic EL element A and the data signal for the organic EL element B are switched by a switch and output to the data line.

The present Example is different from Example 1 in that the lighting times are the same in the organic EL elements A and B of the same color, and the drive currents are different. Specifically, the data line drive circuit 81 generates data signals for the organic EL elements A and B of the same color and writes different signals in the data line 85 to supply different drive currents to the organic EL elements A and B of the same color. Units that make a difference in luminance ratios of colors between the organic EL elements A and B in the data line drive circuit 81 are the units that generate and supply different data signals to the gate terminals of the drive transistors included in the organic EL elements A and B of the same color in FIG. 11.

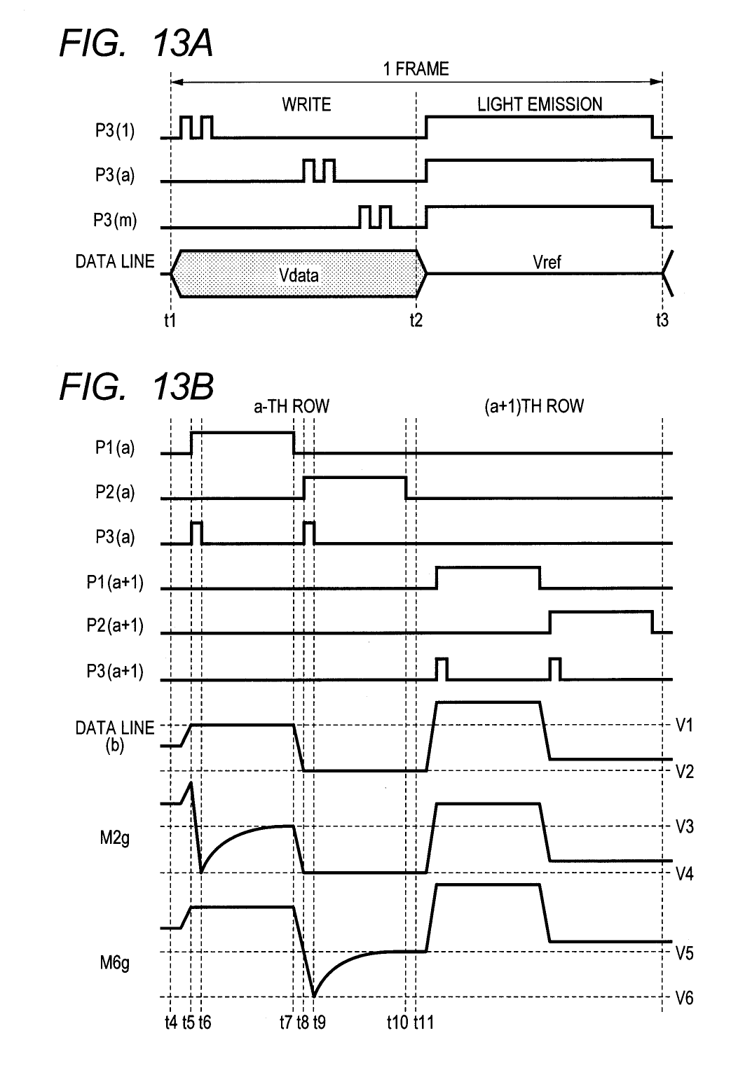

An operation of the pixel circuit of FIG. 11 will be described with reference to timing charts of FIGS. 13A and 13B. In FIGS. 13A and 13B, the horizontal axis denotes time, and the vertical axis denotes ON (HI) and OFF (LOW) of P1 to P3, the voltage of the data line, a gate potential M2g of M2, and a gate potential M6g of M6.

FIG. 13A is a timing chart illustrating writing and light emitting operations in one frame. In FIG. 13A, from t1 to t2 is a writing period of each row, and from t2 to t3 is a light emitting period of all rows.

The writing period (t1 to t2) of FIG. 13A will be described. In P3, the gate line drive circuit 82 continuously outputs pulses so that writing is performed every one horizontal period. In the target row of writing, such as an a-th row, two HI pulses are output from P3(a). The data line outputs the data signal Vdata. In the row, the data line drive circuit 81 outputs the data signal Vdata, in the order of the organic EL element A and the organic EL element B.

A detailed operation of writing of the pixel circuit will be described with reference to FIG. 13B.

In a period of t4 to t5, a data signal Vdata=V1 to be written in the organic EL element A is output to the data line.

In a period of t5 to t6, P1(a) and P3(a) become HI, and M1 and M3 are turned on. The potential of the gate terminal of M2 becomes the same as the potential of the anode electrode of the organic EL element A (V4). In this case, a current flows through the organic EL element A, and light is emitted. The period is controlled so that the light emission is at a level that does not pose a problem.

In a period of t6 to t7, M3 is turned off. At this point, M1 is still ON, and M2 enters a diode connection state. In the period of t5 to t6, the gate potential of M2 converges from V4 to a voltage (V3) which is a power supply potential (hereinafter called “Voled”) minus a threshold voltage Vth of M2.

In a period of t7 to t8, P1(a) becomes LOW, and M1 is turned off. At this point, a different voltage of V1, Voled—Vth, is stored in the capacity C1, and the writing operation in the organic EL element A is finished. A data signal Vdata=V2 to be written in the organic EL element B is output to the data line.

In a period of t8 to t9, P2(a) and P3(a) become HI, and M5 and M4 are turned on. The potential of the gate terminal M6 becomes the same as the potential of the anode electrode of the organic EL element B (V6). In this case, a current flows through the organic EL element A, and light is emitted. The period is controlled so that the light emission is at a level that does not pose a problem.

In a period of t9 to t10, M4 is turned off. At this point, M5 is still ON, and M6 enters a diode connection state. In the period of t8 to t9, the gate potential of M6 converges from V6 to a voltage (V5) which is a power supply potential (hereinafter, called “Voled”) minus a threshold voltage Vth of M6.

In a period of t10 to t11, P2(a) becomes LOW, and M5 is turned off. At this point, a differential voltage V2, Voled—Vth, is stored in the capacity C2, and the writing operation in the organic EL element B is finished.

After t11, the period moves to a writing period of another row. The data line changes according to the data signal of the target pixel. Although the gate potential of M2 and the gate potential of M6 change according to the change in the data line, the potential differences of the capacities C1 and C2 change while maintaining the state during writing.

The light emitting period (t2 to t3) of FIG. 13A will be described. After writing of up to m-th row is finished, P3 (1 to m) of all rows output HI pulses at once in the light emitting period. The signal Vdata output to the data line becomes a fixed potential Vref. The gate potential of M2 and the gate potential of M6 change according to the writing signals of other rows while maintaining the potential differences between the capacity terminals during writing. In a state in which the voltage is fixed at the voltage Vref during light emission, the potentials are V3−(V1−Vref) and V5−(V2−Vref), respectively.

The voltage-current characteristics of the TFT is generally expressed by β (current amplification factor)×(Vgs (gate-source voltage)−Vth)². The current Id1 that flows through the organic EL element A is calculated from the formula. The gate potential of M2 is (Voled−Vth)−(V1−Vref), and the voltage of Vgs is Voled−(Voled−Vth−(V1−Vref)), i.e. Vgs=Vth+V1−Vref. Therefore,

Id1=β(current amplification factor)×(V1−Vref)². (Expression 1)

Similarly, a current Id2 that flows through the organic EL element B is

Id2=β(current amplification factor)×(V2−Vref)². (Expression 2)

In the present Example, based on the microlens disposed over the light emission side of the organic EL element B, the front luminance of the sub-pixels including the organic EL elements A:the front luminance of the sub-pixels including the organic EL elements B=1:4 when the same current is supplied to the organic EL elements A and B for light emission. The ratios of current-time product per frame of the organic EL element A and the organic EL element B=4:0, 3:1, 2:2, 1:3, and 0:4. The ratio of front luminance and the ratios of current-time product are taken into account to set the drive currents of the organic EL element A and the organic EL element B.

A case in which the “wide viewing angle mode” and the “power saving mode” can be selected will be described. Based on the ratio of front luminance and the ratios of current-time product, there are five drive current ratios of 16:0, 12:1, 8:2, 4:3, and 0:4 for the organic EL elements A and B. The present Example includes the units that generate and supply different data signals to the gate terminals of the drive transistors included in the two organic EL elements that emit light of the same color. Therefore, the data signals V1 and V2 that satisfy the five drive current ratios can be set. When the elements are lit in this way, the “wide viewing angle mode” and the “power saving mode” can be selected, and intermediate states between the “wide viewing angle mode” and the “power saving mode” can also be selected as described in the second embodiment. Therefore, high image quality can be realized.

A case in which the “wide viewing angle mode” and the “outdoor visibility mode” can be selected will be described. Based on the ratio of front luminance and the ratio of current-time product, there are five drive current ratios of 4:0, 3:4, 2:8, 1:12, and 0:16 for the organic EL elements A and B. The present Example includes the units that generate and supply different data signals to the gate terminals of the drive transistors included in the two organic EL elements that emit light of the same color. Therefore, the data signals V1 and V2 can be set to satisfy the five drive current ratios. When the elements are lit in this way, the “wide viewing angle mode” and the “outdoor visibility mode” can be selected, and intermediate states between the “wide viewing angle mode” and the “outdoor visibility mode” can also be selected as described in the second embodiment. Therefore, high image quality can be realized.

In the present Example, Expressions 1 and 2 allow the drive that does not depend on Vth in a process with manufacturing variations in the thresholds of the TFTs. Therefore, the variations can be reduced, and the drive with stable quality is possible.

### Example 3

The organic EL panel of the present Example is the same as in FIG. 10, and the pixel configuration of the display apparatus and the pixel arrangement of the present Example are the same as in FIGS. 7B and 7C. Therefore, the description will not be repeated.

FIG. 14 illustrates a pixel circuit of the present Example, and part of the pixel circuit is different from the pixel circuit of FIG. 11. The differences from the pixel circuit of FIG. 11 are that the gate line P1 is connected to the gate terminal of the TFT (M5), and a TFT (M7), a TFT (M8), a TFT (M9), a TFT (M10), a voltage line Vref1, and a voltage line Vref2 are added. The drain terminal of the TFT (M7) is connected to the data line, and the source terminal of the TFT (M7) is connected to one end of the capacity C1. The source terminal of the TFT (M8) is connected to the voltage line Vref1, and the drain terminal of the TFT (M8) is connected to the one end of the capacity C1. The drain terminal of the TFT (M9) is connected to the data line, and the source terminal of the TFT (M9) is connected to one end of the capacity C2. The source terminal of the TFT (M10) is connected to the voltage line Vref2, and the drain terminal of the TFT (M10) is connected to the one end of the capacity C2. The gate terminal of the TFT (M7), the gate terminal of the TFT (M8), the gate terminal of the TFT (M9), and the gate terminal of the TFT (M10) are connected to the gate line P1. When one of the TFT (M7) and the TFT (M8) or one of the TFT (M9) and the TFT (M10) is ON, the other is OFF. The TFTs complementarily operate.

The present Example is the same as the second embodiment that the lighting times are the same in the organic EL elements A and B of the same color, and the drive currents are different. The differences from the second Example are that the data line 85 of FIG. 10 writes the same data signal in the organic EL elements A and B of the same color, and the drive currents supplied to the organic EL elements A and B of the same color in the pixel circuits are different. Units that supply different drive currents to the organic EL elements A and B of the same color in the pixel circuits are the voltages (reference voltages) Vref1 and Vref2 applied to the gate terminal of M2 and the gate terminal of M6 in FIG. 14.

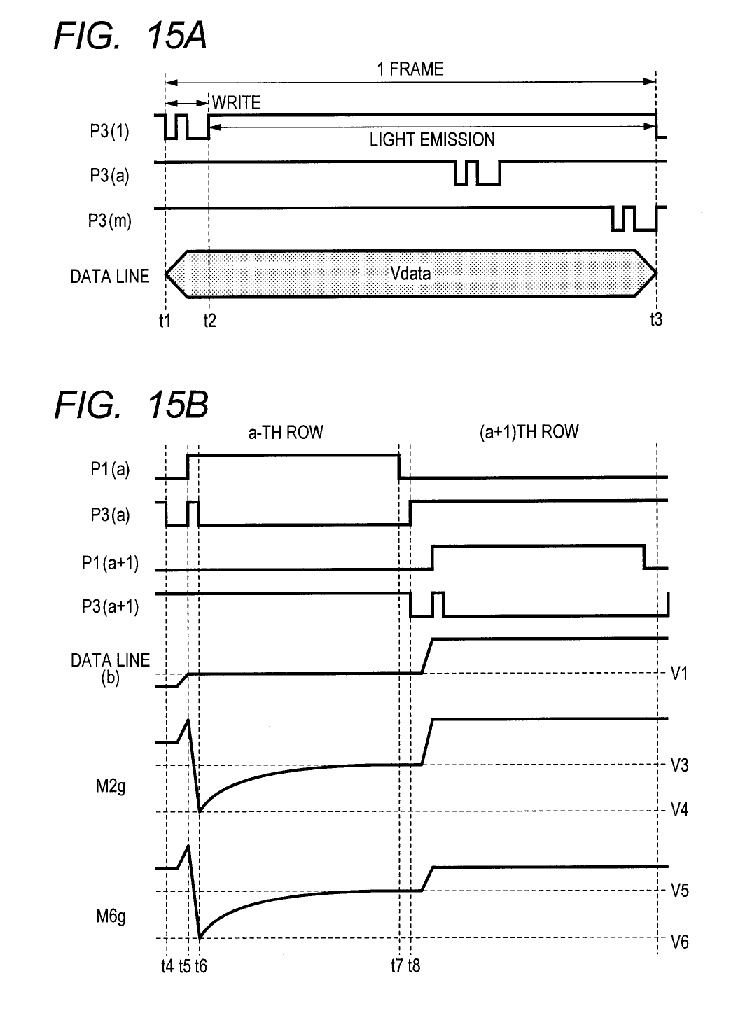

An operation of the pixel circuit of FIG. 14 will be described with reference to timing charts of FIGS. 15A and 15B. In FIGS. 15A and 15B, the horizontal axis denotes time, and the vertical axis denotes ON (HI) and OFF (LOW) of P1 and P3, the voltage of the data line, the gate potential M2g of M2, and the gate potential M6g of M6.

FIG. 15A is a timing chart illustrating a writing operation and a light emitting operation in one frame.

From t1 to t2 is a writing period of the first row, and from t2 to t3 is a light emitting period of the first row and a writing period of the rows other than the first row. A light emitting operation is performed after sequential writing operations from the first row to an m-th row, and after the m-th row, the sequential operations are repeated from the first row. The data signal Vdata is output to the data line.

A detailed operation of writing of the pixel circuit will be described with reference to FIG. 15B.

In the period of t4 to t5, the data signal Vdata=V1 is output to the data line.

In the period of t5 to t6, P1(a) and P3(a) become HI, and M1, M3, M4, M5, M7, and M9 are turned on. The potential of the gate potential of M2 becomes the same as the potential of the anode electrode of the organic EL element A (V4). The potential of the gate potential of M6 becomes the same as the potential of the anode electrode of the organic EL element B (V6). In this case, a current flows through the organic EL element A and the organic EL element B, and light is emitted. The period is controlled so that the light emission is at a level that does not pose a problem. The data signal Vdata equals to v1 at the one end of the capacity c1 and at the one end of the capacity C2.

In the period of t6 to t7, M3 and M4 are turned off. In this case, M1 and M5 are still ON, and M2 and M6 enter a diode connection state. In the period of t5 to t6, the gate potential of M2 converges from V4 to a voltage (V3) which is a power supply potential (hereinafter, called “Voled”) minus a threshold voltage Vth1 of M2. The gate potential of M6 converges from V4 to a voltage (V5) which is a power supply potential (hereinafter, called “Voled”) minus a threshold voltage Vth2 of M6.

In the period of t7 to t8, P1(a) becomes LOW, and M1, M5, M7, and M9 are turned off. In this case, a differential voltage V1, Voled−vth1 is stored in the capacity C1, and the writing operation in the organic EL element A is finished. At the same time, a differential voltage of V1, Voled−Vth2, is stored in the capacity C2, and the writing operation in the organic EL element is also finished. M8 and M10 are turned on. Therefore, the voltage at one end of the capacity C1 becomes Vref1, and the voltage at one end of the capacity C2 becomes Vref2. The potential differences of the capacities C1 and C2 change while maintaining the state during writing. As a result, the gate potential of M2 and the gate potential of M6 are V3−(V1−Vref1) and V5−(V1−Vref2), respectively.

P3(a) becomes HI after t8, and a light emitting operation is performed in an a-th row. The period moves to a writing period of the next row (a+1-th row).

The voltage-current characteristics of the TFT is generally expressed by β(current amplification factor)×(Vgs (gate-source voltage)−Vth)². The current Id1 that flows through the organic EL element A is calculated from the formula. The gate potential of M2 is Vg=(Voled−Vth1)−(V1−Vref), and the voltage of Vgs is Voled−(Voled−Vth1−(V1−Vref)), i.e. Vgs=Vth1+V1−Vref. Therefore,

Id1=β×(V1−Vref1)². (Expression 3)

Similarly, a current Id2 that flows through the organic EL element B is

Id2=β×(V2−Vref2)². (Expression 4)

In the present Example, based on the microlens disposed over the light emission side of the organic EL element B, the front luminance of the sub-pixels including the organic EL elements A:the front luminance of the sub-pixels including the organic EL elements B=1:4 when the same current is supplied to the organic EL elements A and B for light emission. The ratios of current-time product per frame of the organic EL element A and the organic EL element B=4:0, 3:1, 2:2, 1:3, and 0:4. The ratio of front luminance and the ratios of current-time product are taken into account to set the drive currents of the organic EL element A and the organic EL element B.

A case in which the “wide viewing angle mode” and the “power saving mode” can be selected will be described. Based on the ratio of front luminance and the ratios of current-time product, there are five drive current ratios of 16:0, 12:1, 8:2, 4:3, and 0:4 for the organic EL elements A and B. The present Example includes the units that supply different voltages to the gate terminals of the drive transistors included in the two organic EL elements that emit light of the same color. Therefore, the voltages Vref1 and Vref2 that satisfy the five drive current ratios can be set. When the elements are lit in this way, the “wide viewing angle mode” and the “power saving mode” can be selected, and intermediate states between the “wide viewing angle mode” and the “power saving mode” can also be selected as described in the third embodiment. Therefore, high image quality can be realized.

A case in which the “wide viewing angle mode” and the “outdoor visibility mode” can be selected will be described. Based on the ratio of front luminance and the ratios of current-time product, there are five drive current ratios of 4:0, 3:4, 2:8, 1:12, and 0:16 for the organic EL elements A and B. The present Example includes the units that supply different voltages to the gate terminals of the drive transistors included in the two organic EL elements that emit light of the same color. Therefore, the voltages Vref1 and Vref2 can be set to satisfy the five drive current ratios. When the elements are lit in this way, the “wide viewing angle mode” and the “outdoor visibility mode” can be selected, and intermediate states between the “wide viewing angle mode” and the “outdoor visibility mode” can be selected as described in the third embodiment. Therefore, high image quality can be realized.

In the present Example, Expressions 3 and 4 allow the drive that does not depend on Vth in a process with manufacturing variations in the thresholds of the TFTs. Therefore, the variations can be reduced, and the drive with stable quality is possible.

The voltage Vref1 and the voltage Vref2 are different. Therefore, even if M2 and M6 write the same current amplification factor β and the same data signal V1, different currents Id1 and Id2 can be applied to the organic EL element A and the organic EL element B.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-257541, filed Nov. 18, 2010, which is hereby incorporated by reference herein in its entirety.

What is claimed is:

1. An organic electroluminescent display light emitting apparatus comprising:
a plurality of pixels arranged in a matrix;
an organic electroluminescent element arranged on each of the pixels;
a data line driver that supplies a data signal according to image data to each of the pixels;
a pixel circuit that is arranged on each of the pixels and includes a plurality of transistors, the pixel circuit supplying a drive current according to the data signal to the organic electroluminescent element to light the organic electroluminescent element, wherein
each of the pixels includes two organic electroluminescent elements that emit light of a same color,
an element with high light-collecting property is disposed over a light emission side of only one of the two organic electroluminescent elements, and
the apparatus further comprising units that make a difference in lighting times or drive currents between the two organic electroluminescent elements.

2. The organic electroluminescent display apparatus according to claim 1, wherein
the element with high light-collecting property is a microlens.

3. The organic electroluminescent display apparatus according to claim 1, wherein
the units that make a difference in drive currents are disposed each of the two organic electroluminescent elements, and the units separately control lighting and lights-out of each of the two organic electroluminescent elements.

4. The organic electroluminescent display apparatus according to claim 1, wherein
each pixel circuit includes, in each of the two organic electroluminescent elements, a drive transistor that supplies a drive current,
the units that make a difference in drive currents are arranged in the data line driver, and the units generate and supply different data signals to gate terminals of the driver transistors.

5. The organic electroluminescent display apparatus according to claim 1, wherein
each pixel circuit includes, in each of the two organic electroluminescent elements, a drive transistor that supplies a drive current, and
the units that make a difference in drive currents supply different voltages to gate terminals of the drive transistors.
